(19) United States
(12) Patent Application Publication
(10) Pub. No.: US 2011/0094068 A1
(43) Pub. Date: Apr. 28, 2011

(54) HOSE CLAMP

(75) Inventors: Mathias KRAUSS, Nidderau (DE); Frank LANGE, Frankfurt/Main (DE); Thomas LEGEL, Rodgau (DE)

(73) Assignee: NORMA GERMANY GMBH, Maintal (DE)

(21) Appl. No.: 12/913,318

(22) Filed: Oct. 27, 2010

(30) Foreign Application Priority Data
Oct. 28, 2009 (DE) 10 2009 051 128.8

(51) Int. Cl. B65D 63/08; B65D 63/00; B23P 19/00

(52) U.S. Cl. 24/274 R; 24/278; 29/428; 29/525.11

(57) ABSTRACT

Hose clamp and method of forming the hose clamp. Hose clamp includes a clamping band and a turnbuckle, which is attached to an end section of the clamping band and which includes a housing and a clamping screw. The housing has a base wall with a shaping that engages in the clamping band. The shaping, on a side facing towards the clamping band, has a projection and on a side facing away from the clamping band, has a recess that covers a larger area than the projection.

### CROSS-REFERENCE TO RELATED APPLICATIONS

The present application claims priority under 35 U.S.C. §119 of German Patent Application No. 10 2009 051 128.8, filed on Oct. 28, 2009, the disclosure of which is expressly incorporated by reference herein in its entirety.

### BACKGROUND OF THE INVENTION

1. Field of the Invention

The invention relates to a hose clamp, in particular a worm thread clamp, which has a clamping band and a turnbuckle, which is attached to an end section of the clamping band, which includes a housing and a clamping screw. A base wall of the housing has a shaping that engages in the clamping band.

2. Discussion of Background Information

A hose clamp of this type is known, for example, from DE 102 14 663 A1, the disclosure of which is expressly incorporated by reference herein in its entirety. Here one end of the housing in the circumferential direction is bent over radially inwards and engages in a through opening in the clamping band.

The load capacity of a hose clamp is determined, among other things, by how the transfer of force from the clamping band to the housing is realized. With the clamping forces occurring, the clamping band must remain reliably engaged with the housing. If the clamping band slips through with respect to the housing, it is not possible to tighten the clamp with the necessary force.

On the other hand, it is desirable to be able to produce the housing in a simple manner in order to keep production costs low.

### SUMMARY OF THE INVENTION

Embodiments of the invention provide a hose clamp with a high load capacity.

Accordingly, a hose clamp of the type mentioned at the outset in that the shaping, on a side facing towards the clamping band, has a projection and, on a side facing away from the clamping band, has a recess. The recess covers a larger area than the projection.

A shaping of this type can be produced in a simple manner in that an embossing or indentation is made in the base wall. However, due to the special geometry of the shaping, the entire material is not deformed from the recess into the projection, but regions remain in the base wall that surround the projection. In these regions, the base wall has increased tensile strength. The projection is therefore very stable on the “inside” of the housing and furthermore is connected to the base wall with sufficient strength. The projection can thus absorb high tensile forces that are transferred from the clamping band onto the base wall of the housing.

It is particularly preferred hereby for the recess to have a greater volume than the projection. The difference in volume is therefore displaced into the base wall. The base wall is greatly reinforced. This furthermore renders possible a high load capacity of the hose clamp.

Preferably, the recess has a radial depth that is no more than 50% of the thickness of the base wall. The recess thus penetrates only a part of the radial thickness of the base. Sufficient material remains via which the projection can introduce forces into the base wall.

Preferably, the clamping band has a through opening into which the shaping engages. The production of the clamping band is kept simple thereby. Only a through opening needs to be produced, for example, by punching.

Preferably, the shaping is formed by a cold working. A high degree of reinforcement results due to a cold working. The base wall is given an improved torsional stiffness in the region of the shaping.

The housing is preferably formed from a sheet metal part shaped into a tunnel. The ends of the sheet metal part are engaged with one another in the base wall to form a kerf. The shaping is arranged between two sections of the kerf that run perpendicular to a circumferential direction. Another aspect with the load capacity of the hose clamp is the ability of the housing to absorb torsional forces. This applies in particular with a worm thread clamp. A good torsional stiffness is produced with a housing that is embodied or formed as it were in a seamless manner, i.e., formed from a tube. However, a housing of this type requires a relatively high expenditure in the production thereof. Therefore, in the present case, a sheet metal part is used that is flat, for example, at the start of production, which is deformed such that its ends are arranged adjacent to one another. Due to the sections of the kerf running perpendicular to the circumferential direction between the two ends, forces in the circumferential direction, which act on the base wall when the hose clamp is loaded and can lead to twisting are now absorbed, so that these torsional forces can be relatively large. The term “perpendicular to the circumferential direction” should not be understood in the mathematically exact sense here. However, the sections of the kerf should be aligned such that they can absorb the referenced forces to an adequate extent.

Preferably, the sections form a part of a delimited hammer contour having a head section and a handle section. The shaping is then arranged in the handle section. On the other side of the shaping, the hammer contour widens to the head section. A reinforcement of the base wall against torsional forces is thereby achieved.

It is preferred that the end of the sheet metal part that does not have the hammer contour, at least one web runs parallel to the handle section, and projects over the axial center of the base wall. At least one further section of the kerf is thus created, which runs essentially perpendicular to the circumferential direction and therefore is able to absorb forces that act in the circumferential direction. The base wall and thus the entire housing are embodied or formed in a substantially more stable manner.

Preferably, the housing has symmetrical outer dimensions in the circumferential direction and/or in the axial direction. It is thus possible to assemble the housing with the clamping band in two orientations, which simplifies automation in production. This possibility is available, although the housing has a higher load capacity.

Embodiments of the invention are directed to a hose clamp that includes a clamping band and a turnbuckle, which is attached to an end section of the clamping band and which includes a housing and a clamping screw. The housing has a base wall with a shaping that engages in the clamping band. The shaping, on a side facing towards the clamping band, has a projection and on a side facing away from the clamping band, has a recess that covers a larger area than the projection.

According to other embodiments, the hose clamp can be structured as a worm thread clamp.

In accordance with still other embodiments, the recess can have a volume greater than that of the projection.

According to aspects of the embodiments, the recess may have a radial depth that is no more than 50% of a thickness of the base wall.

In accordance with other aspects of the embodiments of the invention, the clamping band may further include a through opening into which the shaping engages.

According to still other embodiments, the shaping can be formed by a cold working.

In accordance with other embodiments, the housing may further include a tunnel formed from a sheet metal part having ends engaged with one another in the base wall and form a kerf. The shaping may be arranged between two sections of the kerf that run perpendicular to the circumferential direction of the tunnel. The two sections can form a part delimiting a hammer contour with a head section and a handle section. Further, one of the ends of the sheet metal part, which does not have the hammer contour, may have at least one web running parallel to the handle section that projects over the axial center of the base wall.

According to other embodiments of the invention, the housing can have symmetrical outer dimensions in at least one of a circumferential direction and an axial direction.

Embodiments of the invention are directed to a method of forming a hose clamp. The method includes forming a housing from a sheet metal part. The housing includes a base wall having a shaping with a projection on an interior of the housing and a recess on an exterior of the housing. The method also includes inserting the shaping through an opening in an end of a clamping band.

According to embodiments of the instant invention, the recess can cover a larger area than the projection.

In accordance with other embodiments, prior to forming the housing, the method can further include forming a hammer contour having a head section and a handle section in a first end of the sheet metal part, and forming at least one web running parallel to the handle section in a second end of the sheet metal part. After the forming of the housing, the at least one web projects over the axial center of the base wall.

According to aspects of the embodiments, the recess may be formed to have a volume greater than that of the projection.

In accordance with further aspects of the invention, the recess can be formed to have a radial depth that is no more than 50% of a thickness of the base wall.

According to other aspects of the invention, the method can further include cold working the shaping.

In accordance with still yet other embodiments of the present invention, the method can further include inserting a screw into the housing and inserting a second end of the clamping band between the screw and the end of the clamping band.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a diagrammatic representation of a hose clamp, partially in section;

FIG. 2 illustrates a housing of a turnbuckle in perspective representation;

FIG. 3 illustrates the housing from below; and

FIG. 4 illustrates a sectional view of the housing.

### DETAILED DESCRIPTION OF THE EMBODIMENTS OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

A hose clamp 1, which in the present case is embodied as a worm thread clamp, has a clamping band 2, which is bent in an annular manner and has an embossed thread 3 on a part of its length.

Hose clamp 1 has a turnbuckle 5 in the region of a first end 4 of clamping band 2. Turnbuckle 5 has a housing 6 and a screw 7. Screw 7 is held in housing 6 in a rotatable and axially captive manner. The other or second end 8 of clamping band 2 is guided through between screw 7 and first end 4. When screw 7 is rotated, second end 8 is drawn further into turnbuckle 5 or pressed out therefrom. Hose clamp 1 can be tightened by the drawing-in.

First end 4 has a section 9, which is bent around a base wall 10 of housing 6. Section 9 ends in a rear flank 11, via which at least a part of the tensile forces can be transferred from clamping band 2 to housing 6 when hose clamp 1 is tightened. Furthermore, section 9 has a through opening 12, into which a projection 13 projects, which is embodied or formed on base wall 10 of housing 6. Further details can be seen illustrated in FIGS. 2-4.

Projection 13 forms a part of a shaping 14 in base wall 10. Shaping 14 has a recess 15 on the radial outside and the above-mentioned projection 13 on the radial inside of base wall 10 of housing 6. As can be seen in particular in FIG. 4, recess 15 covers a larger area than projection 13. When recess 15 and projection 13 are embodied or formed in a circular manner, recess 15 has a larger diameter than projection 13. Further, recess 15 can completely covers projection 13. Shaping 14 can be formed by a cold working. Moreover, housing 6 is made of a metal sheet. The metal can be given an increased strength with a cold working. Through the embodiment shown of shaping 14, sections 16, 17 of base wall 10 are produced, into which it is displaced during production of shaping 14. Then an increased strength is produced there, even if the material of base wall 10 is thinner here than in the other region of base wall 10. However, the thickness of regions 16, 17 can still be at least 50% of the thickness of base wall 10. Otherwise, the depth of recess 15 is no more than 50% of the thickness of base wall 10. Therefore, through the production of shaping 14, not only projection 14 is provided with an increased strength, but also its connection to base wall 10.

It is also discernible that recess 15 has a larger volume than projection 13. The material difference has therefore been compressed into sections 16, 17.

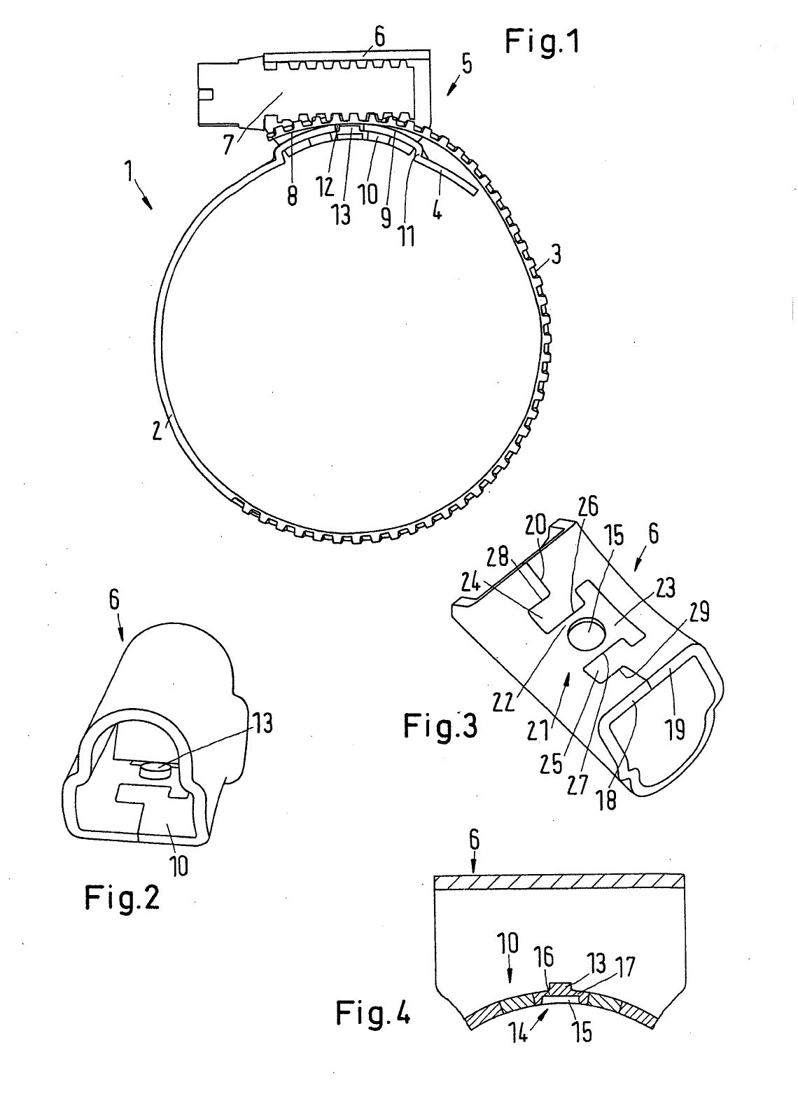

As mentioned above, housing 6 is formed by a sheet metal part that has been shaped to form a tube or tunnel (FIG. 2), for example, by bending. Base wall 10 is therefore formed by two end sections 18, 19 of this sheet metal part, which meet at a kerf 20. Kerf 20 runs in the region of its ends in the circumferential direction approximately in the axial center of housing 6. All of the directional data relate to the representation in FIG. 1.

First end section 18 forms a hammer contour 21 with a handle section 22 and a head section 23. Recess 15 is arranged in handle section 22. Second end section 19 has a correspondingly negative form thereto. However, second end section 19 has two webs 24, 25, which run parallel to handle section 22 and project beyond the axial center of housing 6. On both sides of handle section 22, sections 26, 27 of kerf 20 are thus produced, which are aligned essentially perpendicular to the circumferential direction of housing 6. Furthermore, two further sections 28, 29 are produced on the outer sides of webs 24, 25 in the circumferential direction, which further sections are likewise aligned essentially perpendicular to the circumferential direction of housing 6. The force against twisting, which hammer contour 21 must absorb, is thus additionally absorbed as well. The result of this is that the torsional forces that act on base wall 10 when hose clamp 1 is loaded can be much stronger than without webs 24, 25.

It is discernible that a comparatively small material region remains between recess 15 and two sections 26, 27 of kerf 20. This material region must accommodate the material displaced during the production of shaping 14. It is thereby very greatly reinforced. Handle section 22 is thus substantially reinforced. At the same time the limit stops of clamping band 2 on base wall 10, in particular flank 11, are markedly relieved through projection 13 formed thereby. Hose clamp 1 can now be designed such that it develops higher clamping forces or can be used with higher torques.

Housing 6 has symmetrical outer dimensions, preferably in the circumferential direction as well as in the axial direction. It is therefore unimportant in which orientation housing 6 is assembled with clamping band 2. This facilitates automated production.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A hose clamp comprising:
a clamping band; and
a turnbuckle, which is attached to an end section of the clamping band and which includes a housing and a clamping screw,
the housing has a base wall with a shaping that engages in the clamping band,
wherein the shaping, on a side facing towards the clamping band, has a projection and on a side facing away from the clamping band, has a recess that covers a larger area than the projection.

2. The hose clamp in accordance with claim 1 structured as a worm thread clamp

3. The hose clamp in accordance with claim 1, wherein the recess has a volume greater than that of the projection.

4. The hose clamp in accordance with claim 1, wherein the recess has a radial depth that is no more than 50% of a thickness of the base wall.

5. The hose clamp in accordance with claim 1, wherein the clamping band further includes a through opening into which the shaping engages.

6. The hose clamp in accordance with claim 1, wherein the shaping is formed by a cold working.

7. The hose clamp in accordance with claim 1, wherein the housing further includes a tunnel formed from a sheet metal part having ends engaged with one another in the base wall and form a kerf, and
wherein the shaping is arranged between two sections of the kerf that run perpendicular to the circumferential direction of the tunnel.

8. The hose clamp in accordance with claim 7, wherein the two sections form a part delimiting a hammer contour with a head section and a handle section.

9. The hose clamp in accordance with claim 8, wherein one of the ends of the sheet metal part, which does not have the hammer contour, has at least one web running parallel to the handle section that projects over the axial center of the base wall.

10. The hose clamp in accordance with claim 1, wherein the housing has symmetrical outer dimensions in at least one of a circumferential direction and an axial direction.

11. A method of forming hose clamp comprising:
forming a housing from a sheet metal part, the housing including a base wall having a shaping with a projection on an interior of the housing and a recess on an exterior of the housing; and
inserting the shaping through an opening in an end of a clamping band.

12. The method in accordance with claim 11, wherein the recess covers a larger area than the projection.

13. The method in accordance with claim 11, wherein, prior to forming the housing, the method further includes forming a hammer contour having a head section and a handle section in a first end of the sheet metal part, and forming at least one web running parallel to the handle section in a second end of the sheet metal part.

14. The method in accordance with claim 13, wherein, after the forming of the housing, the at least one web projects over the axial center of the base wall.

15. The method in accordance with claim 11, wherein the recess is formed to have a volume greater than that of the projection.

16. The method in accordance with claim 11, wherein the recess is formed to have a radial depth that is no more than 50% of a thickness of the base wall.

17. The method in accordance with claim 11, further comprising cold working the shaping.

18. The method in accordance with claim 11, further comprising inserting a screw into the housing and inserting a second end of the clamping band between the screw and the end of the clamping band.
